(19) United States
(12) Patent Application Publication
(10) Pub. No.: US 2020/0371338 A1
(43) Pub. Date: Nov. 26, 2020

(54) MICROSCOPE ASSEMBLY FOR CAPTURING AND DISPLAYING THREE-DIMENSIONAL IMAGES OF A SAMPLE

(71) Applicant: CARL ZEISS MICROSCOPY GMBH, Jena (DE)

(72) Inventors: Ilja KARANIN, Munich (DE); Alexander GAIDUK, Jena (DE)

(21) Appl. No.: 16/496,609

(22) PCT Filed: Apr. 5, 2018
(86) PCT No.: PCT/EP2018/058678

§ 371 Date: Sep. 23, 2019

(30) Foreign Application Priority Data
Apr. 7, 2017 (DE) 10 2017 107 489.9

(51) Int. Cl. G02B 21/36; G01B 9/04

(52) U.S. Cl. CPC G02B 21/367; G06T 17/00; G01B 9/04

(57) ABSTRACT

The present invention relates to a microscope assembly for the three-dimensional capture of a sample to be microscopically examined and for the display of three-dimensional images of the sample under the microscope. The microscope assembly comprises an image capture unit for obtaining photographs of the sample and an image processing unit for generating three-dimensional images of the sample from the photographs of the image capture unit. In addition, the microscope assembly comprises at least one display unit for the three-dimensional display of the generated threedimensional images of the sample. According to the invention, the microscope assembly for generating and displaying the three-dimensional images of the sample is configured with an image refresh rate of at least 1 frame per second.

### BACKGROUND OF THE INVENTION

The present invention relates to a microscope arrangement for three-dimensionally recording a sample to be examined and for presenting three-dimensional images of the sample under the microscope.

For specific applications, microscopes that make three-dimensional display of an object under the microscope possible in real time are required. Typical areas of use are for example surgical microscopes, applications in electron microscopy and X-ray microscopy and also microscopy for bio research and for routine work. In order to impart a three-dimensional impression, stereo microscopes are currently used in these applications which produce pseudo-three-dimensional displays only in combination with human vision. Known stereo microscopes require that the user has the ability to produce a stereo image from the images obtained. However, three-dimensional impressions are not available.

Some digital microscopes make three-dimensional presentation of an object under the microscope possible. These solutions available herefor have no real-time capability.

EP 2 671 114 B1 describes an imaging system for microscopic recordings and presentations. The system comprises an apparatus for capturing depth information, an apparatus for active real-time monitoring of a position of one or both eyes of a user, and means for configuring two-dimensional display contents, which are dependent on the captured eye position.

US 2015/0032414 A1 teaches a method for three-dimensionally measuring a sample. This method makes it possible for a plurality of users to observe and examine the sample at the same time. This solution is based on a laser scanning microscope (LSM). The real-time capability of the laser scanning microscope is limited by the data capturing that is based on scanning.

The commercially available product “3D WiseScope microscope” from SD Optics Inc. permits fast generation of macroscopic and microscopic images, which have an extended depth of field (EDoF). The focus setting can be modified with a frequency of 1 to 10 kHz and more. A mirror array lens system, referred to as a MALS module, serves to implement the EDoF functionality. MALS denotes a mirror array lens system.

Stereo microscopes are frequently used to examine microscopic environments three-dimensionally and in real-time, for which navigation in all three dimensions and in real-time is required. Spatial perception using a stereo microscope is based on the abilities of the human sense of sight to accommodate and to reconstruct a spatial image in the brain. An examination and navigation without eyepiece is likewise based on the abilities of the human sense of sight, but utilizes a different optical technology to transfer the stereo image to the optical output. Nevertheless, the digital documentation of spatial microscopic information is difficult and frequently slow, which means that it is not comparable to the natural visual perception in real time. This for one thing has physical reasons. For example, not every user is able to spatially visualize the images captured using a stereo microscope. Working with the eyepiece or the three-dimensional display of stereo microscopes is additionally very strenuous for many users.

WO 2016/078923 A1 illustrates an apparatus for stereoscopic viewing, in which a stereoscopic image is produced from two video images. This solution requires two projectors for projecting the two video images, a concave mirror arrangement and a viewing lens. The two images to be projected differ spatially and/or in terms of their orientation with respect to the object to be presented.

DE 10 2015 118 154 A1 illustrates a surgical microscope, which can also be embodied as a stereo microscope. The surgical microscope comprises an adjustment device for changing a focal position of a camera unit. A secondary image data set having an extended depth of field is ascertained from a primary image data set produced for a plurality of focus values. The secondary images are produced and displayed with a frequency of at least 25 Hz.

DE 10 2005 032 354 A1 illustrates a method for image recording with an extended depth of field range as part of the microscopic scanning of a sample. Using a control system, a variable focus adjustment range for an optical unit is specified. A frame is recorded for each focus value of the focus adjustment range, with the result that a plurality of frames are recorded from whose sections with in each case the greatest contrast a total image is produced in real time. This process should proceed so quickly that the total image can be reproduced on a screen in real time.

US 2004/0264765 A1 illustrates a microscope system in which shadow information within a recorded image are determined, while the focal length of the objective is changed and the respective focal position is measured. An all-in-focus image and a height map of the object are determined to ascertain therefrom a three-dimensional image. Focusing the all-in-focus image should proceed in real time.

DE 10 2016 108 664 A1 teaches a digital stereo surgical microscope with at least two image recording units for recording an object from two different angles. The stereo surgical microscope has a topography generator for generating topography data from the radiation data recorded by the image recording units. The stereo surgical microscope furthermore has a presentation generator for generating a stereo view and at least two image presentation units for making stereo images available for a plurality of users. A realistic presentation of the operating field in real time is to be achieved by the topography generator and the presentation generator being suitable for displaying a stereoscopic view in less than 50 ms.

US 2015/0173715 A1 discloses a method for the ultrasound diagnosis of internal tissue in which a three-dimensional display is effected for example using Pepper's ghost principle.

DE 698 00 802 T2 illustrates a set of lenses for a microscope with a means for the continuous oscillation of a focal length of the set of lenses. A quick and sequential presentation of sharp images is to be performed to obtain unlimited depth of field. By way of example, the microscope can be embodied as a binocular microscope.

DE 10 2006 025 149 A1 describes a stereo microscope with a device for changing the depth of field. This device is formed for example by a micromirror array which is actuated cyclically with a frequency, wherein said frequency is greater than or equal to the flicker fusion frequency.

DE 10 2008 037 074 A1 discloses a method for controlling an aperture stop in a microscope, by way of which in particular a depth of field optimization in a stereoscope is to be attained. The aperture stop is formed by a controllable transmission display that is operated with a frequency near the flicker fusion frequency.

### SUMMARY OF THE INVENTION

Proceeding from the prior art, it is the object of the present invention to provide a microscope arrangement with which a more realistic three-dimensional reproduction of a sample under a microscope is possible.

A microscope arrangement according to the attached claim 1 serves to achieve said object.

The microscope arrangement according to the invention serves for three-dimensionally recording a sample to be examined and for presenting three-dimensional images of the sample under the microscope. The microscope arrangement initially comprises an image recording unit for ascertaining recordings of the sample. The recordings of the sample comprise at least overall information in the X-direction, Y-direction and Z-direction. The information in the Z-direction is preferably obtained from two-dimensional recordings, in particular from two-dimensional recordings having different focus settings. However, these may preferably also be at least two two-dimensional images having a different Z-component. Alternatively, they are preferably two-dimensional images supplemented by a set of three-dimensional data. Alternatively, they are preferably completely three-dimensional images. With particular preference, the recordings that are ascertainable by the image recording unit are two-dimensional recordings having different focus settings and therefore forming what is known as a focus stack or z-stack. The image recording unit is preferably equipped with at least one objective and with at least one image sensor. The objective serves for optically imaging the sample. The image sensor converts the imaged images into an electrical signal. The image recording unit is preferably designed to record two-dimensional images, that is to say recordings of the sample, suitable for producing three-dimensional images. Depth information must be able to be obtained from the recorded two-dimensional images. To this end, the sample can be recorded for example with different sample-side fields of view. In addition, there is the possibility of recording images of the sample with different focal positions, or with different illumination directions, or with different illumination directions, illumination conditions and different focal positions. The image recording unit is preferably embodied for recording images with extended depth of field, for which the image recording unit preferably comprises a microsystem having mechanically movable micromirrors (MALS).

The microscope arrangement furthermore includes an image processing unit for producing three-dimensional images of the sample from the recordings of the image recording unit. The three-dimensional images are presentations that, by a reproduction in all three dimensions, produce in the observer the illusion of a three-dimensional presentation and/or are three-dimensional presentations that can be viewed from all sides. This is therefore not merely a stereoscopic or binocular image because it is not reproducible in all three dimensions since it is merely two two-dimensional views from two different positions that are also only reproducible as two two-dimensional images under this condition. The three-dimensional images are particularly preferably three-dimensional presentations that can be viewed in each case from a plurality of positions and/or from a plurality of sides. The three-dimensional images are with further preference three-dimensional presentations that can be viewed in each case from all positions and/or from all viewed or recorded sides. The three-dimensional images producible by the image processing unit particularly preferably in each case comprise a multiplicity of voxels distributed in three dimensions. The three-dimensional images are therefore in each case a spatial data set present in discretized form in Cartesian coordinates, wherein the voxels in each case represent the discrete value at an XYZ-coordinate of the data set. It is not necessary for each XYZ-coordinate in the data set to be assigned a value, with the result that some voxels are not defined. Preferably only the voxels that represent a surface, in particular a surface of the sample, are defined. In this way, the three-dimensional images are producible and presentable without major outlay.

The three-dimensional images are preferably produced from the recorded two-dimensional images. The three-dimensional images comprising the voxels are preferably in each case produced from the two-dimensional recordings that have different focus settings. To this end, depth information is first ascertained from the two-dimensional recordings having the different focus settings.

The image processing unit is preferably configured such that it can produce at least one of the three-dimensional images of the sample per second. The image processing unit is preferably to be designed for producing more than one three-dimensional image of the sample per second, preferably 10 to 15 three-dimensional images of the sample per second, and with further preference up to 300 three-dimensional images of the sample per second. To this end, the image recording unit must of course have the corresponding operational performance so that the number of two-dimensional images of the sample that is required to generate the three-dimensional images is available. For example, at least two different recordings of the sample must be available for each produced three-dimensional image of the sample. The aforementioned “3D WiseScope microscope” for example has such operational performance. The three-dimensional images of the sample produced using the image processing unit preferably in each case represent a cube having an edge length of at least 1 mm and with further preference at least 10 mm. Said dimensioning, however, is merely an example; three-dimensional images with other suitable dimensions are certainly possible. In the object plane, an optical resolution up to the diffraction limit can be attained.

At least one three-dimensional display unit that serves for the three-dimensional presentation of the three-dimensional images of the sample produced using the image processing unit forms a further constituent part of the microscope arrangement. To this end, it must be ensured that the image processing unit makes available three-dimensional image data in a data format that is suitable for presentation on the three-dimensional display unit. The microscope arrangement comprises, in addition to the three-dimensional display unit, preferably also a two-dimensional display unit. The two display units are preferably configured for the shared presentation of the images of the sample. With alternative preference, the two-dimensional display unit is configured for presenting sectional images or functional elements for measuring the sample or functional elements for operating the microscope arrangement. The image repetition frequencies, or frame rate, of the individual display units can differ depending on the purpose of the content to be presented and the given requirements.

According to the invention, the microscope arrangement is embodied for producing and presenting the three-dimensional images not only as static three-dimensional images but as moving three-dimensional images. The human sense of sight does not perceive the presented three-dimensional images as temporally invariable but as time-dependent, which means that changes in the sample are reproduced synchronously with a delay that is negligible for human perception. For this reason, the microscope arrangement is configured for producing and presenting the three-dimensional images of the sample with an image repetition frequency of at least one three-dimensional image per second. Accordingly, the image processing unit is configured for producing the three-dimensional images of the sample with an image repetition frequency of at least 1 image per second. Accordingly, the display unit is configured for three-dimensionally presenting the three-dimensional images produced of the sample with an image repetition frequency of at least 1 image per second. The image repetition frequency of at least 1 image per second results in the real-time capability of the microscope arrangement. Since the images are three-dimensional images of three-dimensional regions of the sample, which can in each case also be referred to as a volume, the image repetition frequency can also be described as a volume repetition frequency of, according to the invention, at least 1 volume per second.

The image repetition frequency or the volume repetition frequency is here preferably at least 10, with further preference at least 25, images per second or volumes per second.

The major advantage of the microscope arrangement according to the invention can be considered the fact that, compared to the solutions known to date, the present microscope arrangement makes a three-dimensional moving reproduction with extended depth of field/real-time reproduction with extended depth of field of a sample under the microscope possible, for which three-dimensional images of samples under the microscope are produced and presented more quickly. The user thus is provided, in near real-time, with three-dimensional images of the sample for a three-dimensional illusion of the sample that the user can comfortably view using the utilized three-dimensional display unit. The speed of the microscope arrangement according to the invention, as opposed to the prior art, is not limited to a static three-dimensional reproduction due to data capturing that is based for example on scanning.

According to an advantageous embodiment, the microscope arrangement is provided with a data interface for transmitting the data captured by the image recording unit and/or the data prepared by the image processing unit. External devices can be connected to the data interface to transfer the data obtained for example for further processing, to facilitate display at remote display units or possibly to store the data, for example for archiving purposes.

Equipping the microscope arrangement with an electronic control unit has proven advantageous. The control unit can be used to control the image recording unit and/or the image processing unit and/or the display unit. The control unit is preferably integrated in the image processing unit and forms one structural unit therewith. The control unit facilitates an efficient workflow during the operation of the microscope arrangement. The user is preferably required to perform only a few interventions, which can preferably be reduced to switching the corresponding units of the microscope arrangement on and off, triggering the image recording, and triggering the storing of the data that are generated. One preferred embodiment utilizes a control unit having an operating unit that is able to be operated by a user. The operating unit is preferably an electronic mobile device, preferably a freely programmable mobile phone (smartphone), a tablet computer or a similar device. Operating units such as for example computer mice, touchpads, keyboards, sensors for gestures or joysticks can also be used for inputting control commands.

The at least one three-dimensional display unit preferably takes the form of a holographic display unit, an apparatus for producing a three-dimensional moving image reproduction or a three-dimensional display unit that is able to be worn on a user's head (head-mounted display). The aforementioned three-dimensional display units, in particular the three-dimensional display unit that is able to be worn on a user's head (head-mounted display), makes three-dimensional display possible according to the invention in particular due to the fact that the user can select the position and direction of his or her gaze, which has not yet been possible in stereoscopic reproduction known from the prior art alone.

In a further preferred embodiment, the display unit is based on Pepper's ghost principle. To this end, the display unit comprises a plurality of partially transparent mirrors, arranged along the perimeter, and a projection unit that is directed at the partially transparent mirrors. The partially transparent mirrors are preferably formed by semitransparent mirrors. The partially transparent mirrors are partially reflective or semi-reflective. The reflectance or partial transparency of the partially transparent partially reflective mirrors is preferably controllable such that the mirrors are controllably partially reflective mirrors. The projection unit is embodied for the projection of in each case a partial image, assigned to a perspective, of the three-dimensional image that is to be presented in each case onto the individual partially transparent mirrors. In the intermediate space between the partially transparent mirrors, a three-dimensional vision is produced which reproduces the respective three-dimensional image to be presented. The projection unit is preferably embodied for the presentation of two-dimensional images by light. The projection unit is preferably formed by a screen.

The partially transparent mirrors are preferably arranged like the side faces of a pyramid. The pyramid preferably has four side faces, which means that the number of partially transparent mirrors is four. The base of the pyramid is preferably a rectangle. The projection unit is preferably directed onto the pyramid from above. The projection unit in the preferred form of a screen is preferably arranged parallel to the base of the pyramid.

The partially transparent mirrors are arranged with alternative preference in the form of a spheroid, a sphere or an ellipsoid, without the need to entirely simulate the spheroid, the sphere or the ellipsoid. The projection unit is preferably directed onto the spheroid, onto the sphere or onto the ellipsoid from above.

The image recording unit is preferably embodied for recording images with extended depth of field from different perspectives. The image processing unit is preferably embodied for calculating two-dimensional frames of the three-dimensional images that are assigned in each case to a perspective, wherein the two-dimensional frames are projected onto the respective partially transparent mirrors by the projection unit of the display unit. To this end, the image processing unit is preferably embodied for converting the perspectives of the recorded images with extended depth of field into the perspectives of the frames with extended depth of field that are to be presented in the display unit. The display unit is preferably embodied to project the same frames onto the partially transparent mirrors as long as the frames for the different perspectives are not available. To determine the frames from the different perspectives, the image processing unit is preferably embodied to determine a three-dimensional model from the recorded images.

The microscope arrangement in one preferred embodiment is configured such that a plurality of users can observe the produced three-dimensional image data at the same time, wherein the users can be situated at different positions in the room and even move about. In addition, controlling the three-dimensional image data, that is to say navigating and/or interacting with the three-dimensional image data, is preferably additionally made possible individually for each of the plurality of users. The individual users can individually select the view of the sample that has been reproduced. To this end, in particular the control unit and possibly also the display unit need to be configured for simultaneous operation by a plurality of users. For example, the three-dimensional display unit can be positioned at a specific point in the room relative to the image recording unit. Alternatively, there is the possibility of a plurality of users that are equipped with individually wearable three-dimensional display units simultaneously observing the same scene.

The microscope arrangement according to one advantageous embodiment comprises a three-dimensional printer for creating a three-dimensional model of the sample under the microscope. The three-dimensional model can be created using the three-dimensional printer in a desired enlargement. It is subsequently available for further investigations and can be used for comparison to the three-dimensional model that is presented on the three-dimensional display unit. To this end, the printed three-dimensional model should be placed in the display field of the three-dimensional display apparatus. The comparison of the printed three-dimensional model to the displayed three-dimensional model can be manual, semiautomatic or automatic using additional macroscopic digitization means. The additional microscopic digitization means can furthermore make a three-dimensional overview presentation possible for more efficient navigation on the sample or on an enlarged copy of the sample.

The microscope arrangement is preferably equipped with a sample stage for holding the sample, said sample stage being rotatable or tiltable and/or displaceable in the X-direction and/or Y-direction. In this way, the sample can be positioned with great accuracy. In addition, this functionality of the sample stage can be used for recording the sample with different sample-side fields of view.

The electronic control unit of the microscope arrangement according to the invention is preferably configured for performing a method that serves for extending the depth of field without major outlay, such that a sample is able to be imaged without major outlay with an extended depth of field. In one step of this method, the image recording unit is used to record a plurality of images, that is to say a plurality of two-dimensional recordings of a sample, wherein the images are recorded with different focus settings. The recorded images, that is to say the two-dimensional recordings of a focus stack, are thus obtained. The images, that is to say the two-dimensional recordings, are preferably recorded with many different focus settings, ranging from a minimum focus setting of a focusing interval to a maximum focus setting of the focusing interval. At least four images are recorded with different focus settings and, with particular preference, at least 10 images are recorded with different focus settings.

In a further preferred step to be performed, the images are prepared, that is to say the two-dimensional recordings are prepared by removing unsharp image portions in the individual images. The unsharp image portions are preferably detected using a spatial frequency analysis. The unsharp image portions are preferably removed by defining the pixels in said image portions to be transparent.

In a further step, the display unit is used to present the images, that is to say to present the two-dimensional recordings, in a temporal sequence, as a result of which an imaged presentation of the sample with an extended depth of field is produced. Presenting the individual images in a fast temporal sequence produces the impression in the observer of a single imaged presentation of the sample, wherein the imaged presentation for each image region also contains sharp image portions such that an extended depth of field is given. Preferably, a presentation of the prepared images in a temporal sequence is effected. Since the unsharp image portions in the prepared images have been removed, only sharp image portions are presented. Presenting the individual prepared images in a fast temporal sequence produces the impression in the observer of a single imaged presentation of the sample, wherein the imaged presentation does not contain unsharp image portions such that an extended depth of field is given. The preferably prepared images are presented with an image change frequency that is preferably at least as high as the flicker fusion frequency. The two-dimensional images are preferably presented on a partially transparent mirror that is arranged along the perimeter. The image presentation of the sample with extended depth of field is thus produced on the respective partially transparent mirror. Since this embodiment of the display unit comprises a plurality of the partially transparent mirrors arranged along the perimeter, one of the imaged presentations with extended depth of field from one perspective is produced on each of the partially transparent mirrors, with the result that the three-dimensional images are presented three-dimensionally between the partially transparent mirrors.

One particular advantage of this embodiment is that it is possible to dispense with the complicated calculation of a total or composite image with extended depth of field, as a result of which the production and presentation of the three-dimensional images can be accomplished more quickly.

The image recording unit, the image processing unit, and/or the display unit are preferably also embodied for performing the method described.

### DESCRIPTION OF THE DRAWINGS

Further details and developments of the invention will become apparent from the following description of a preferred embodiment, with reference being made to the drawing. In the figures:

FIG. 1 shows a schematic illustration of a preferred embodiment of a microscope arrangement according to the invention;

FIG. 2 shows a display unit of a preferred embodiment of the microscope arrangement according to the invention; and

FIG. 3 shows a flowchart of a method that is preferably performed by a control unit of the microscope arrangement according to the invention.

### DETAILED DESCRIPTION OF THE INVENTION

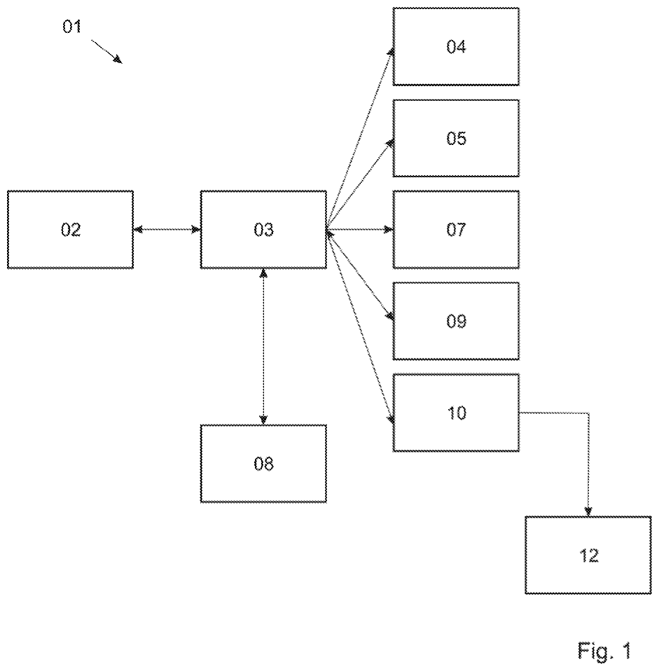

FIG. 1 shows a schematic illustration of a preferred embodiment of a microscope arrangement 01 according to the invention.

The illustrated embodiment of the microscope arrangement 01 according to the invention firstly comprises an image recording unit 02. The image recording unit 02 can be used to record recordings of a sample (not illustrated). The image recording unit 02 is configured for example to provide images that are suitable for producing three-dimensional images. The image recording unit 02 includes at least one illumination module (not shown), an objective (not shown) for optically imaging the sample, and an image sensor (not shown) for converting the imaged images into an electrical signal. Further preferred embodiments, which are not shown, make recordings from different perspectives possible, that is to say at different recording viewing angles, for which purpose the image recording unit 02 is accordingly embodied, for example in that the image recording unit 02 comprises a plurality of spatially distributed image recording apparatuses.

An image processing and control unit 03 forms a further constituent part of the microscope arrangement 01. The components of the image processing and control unit 03 used for image processing produce three-dimensional images of the sample from the images that are recorded by the image recording unit 02. According to the invention, at least one three-dimensional image of the sample per second can be produced. The aim is to produce more than one three-dimensional image of the sample per second. Preferably, it should be possible to generate 10 to 60 images of the sample per second, and with further preference up to 300 images of the sample per second. The components of the image processing and control unit 03 serving for control purposes control the image recording unit 02 and preferably also interact at least with some of the constituent parts of the microscope arrangement 01 that will be described below. In alternative embodiments, the image processing and control unit 03 can be realized by separate assemblies.

The microscope arrangement 01 furthermore comprises a three-dimensional display unit 04 for presenting the three-dimensional images of the sample. The three-dimensional display unit 04 can be embodied for example in the form of a holographic display unit or of a three-dimensional display unit that is wearable on a user's head, such as for example in the form of 3D glasses or a head-mounted display. A two-dimensional display unit 05 serves for presenting two-dimensional images of the sample. It is additionally possible to present three-dimensional and two-dimensional images at the same time or separately using the three-dimensional display unit 04.

A three-dimensional model of the sample is printable using a three-dimensional printer 07. The printed three-dimensional model of the sample can be compared to the three-dimensional model of the sample that is displayed on the three-dimensional display unit 04. To this end, the microscope arrangement 01 is equipped with a comparison unit 08. The comparison unit 08 includes corresponding components for the digitization of the printed three-dimensional model of the sample.

The microscope arrangement 01 furthermore includes an operating unit 09 which can be used to input control commands by users to control the individual units of the microscope arrangement 01. The operating unit 09 is preferably an electronic mobile device, preferably a freely programmable mobile phone or a tablet computer. Alternatively, the operating unit 09 can also be a computer mouse, a touchpad, a keyboard or a joystick. It is additionally possible for functional elements of the operating unit 09 to be presented using the three-dimensional display unit 04 or using the two-dimensional display unit 05 at the same time as the images of the sample.

Furthermore, the microscope arrangement 01 is equipped with a data interface 10. The data that are captured by the image recording unit 02 and/or prepared by the control and image processing unit 03 can be transmitted to external devices 12 via the data interface 10. The external devices 12 for example can make visualization of the data for users located at remote locations possible. Moreover, the data can be processed further, evaluated or delivered to an external storage medium.

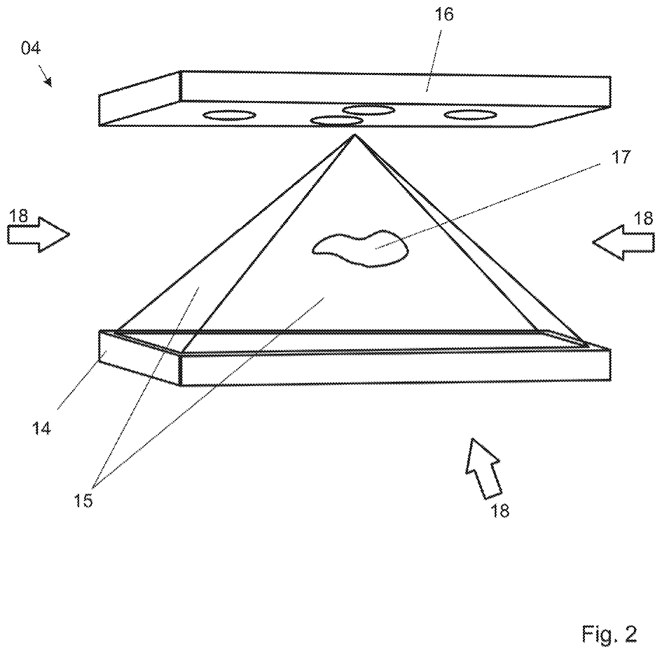

FIG. 2 shows the display unit 04 of a preferred embodiment of the microscope arrangement according to the invention. In this embodiment, the display unit 04 is based on Pepper's ghost principle. The display unit 04 comprises a frame 14, on which three or four partially transparent partially reflective mirrors 15 are mounted along the perimeter. The display unit 04 furthermore comprises a projection unit 16, which is formed by a flat-panel screen and is directed onto the partially transparent mirrors 15 from above. The partially transparent mirrors 15 are arranged like the side faces of a pyramid. The projection unit 16 is embodied for the projection of in each case a partial image, assigned to a perspective, of a three-dimensional image 17 that is to be presented in each case onto the individual partially transparent mirrors 15. The three-dimensional image 17 is produced in the intermediate space between the partially transparent mirrors 15 in the form of a three-dimensional vision, which can be viewed from different perspectives 18.

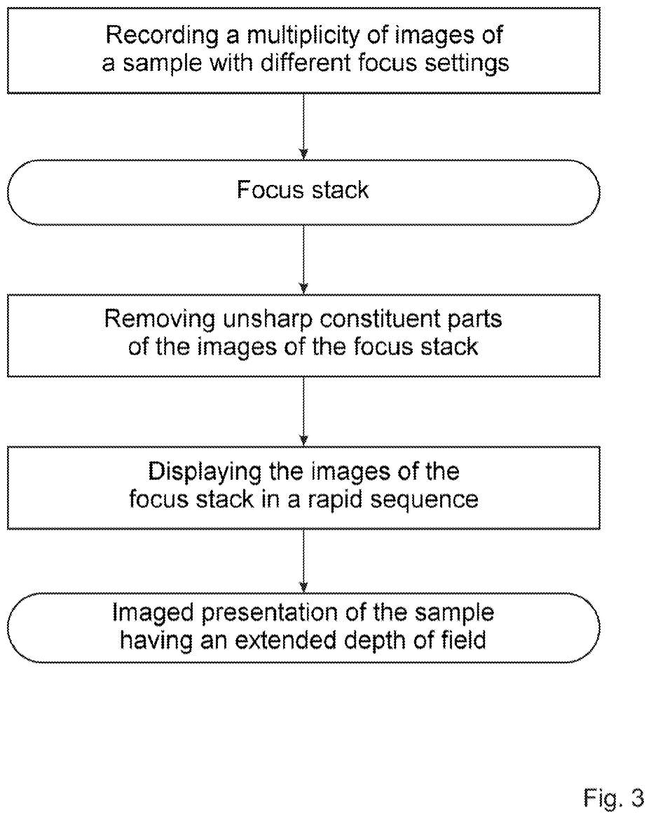

FIG. 3 shows a flowchart of a preferred embodiment of a method which serves for extending the depth of field without major outlay and is implemented by the electronic image processing and control unit 03 (shown in FIG. 1). With this method, it is possible to image a sample without major outlay with an extended depth of field. In one step of this method, a multiplicity of two-dimensional images or recordings of the sample are recorded, wherein the two-dimensional images are recorded with different focus settings. The recorded two-dimensional images or recordings thus form a focus stack and the basis of a three-dimensional image. In a further step, unsharp constituent parts in the individual two-dimensional images are removed or masked, such that the two-dimensional images exhibit substantially only sharp portions. In a further step, the display unit 04 (shown in FIG. 1) is used to present the images, which now only contain the sharp portions, in a rapid temporal sequence, as a result of which an imaged presentation of the sample having an extended depth of field is produced. On account of the display of the imaged presentations with extended depth of field from different perspectives using the display unit 04 (shown in FIG. 1), a three-dimensional presentation of the three-dimensional image formed from the two-dimensional recordings is obtained.

1. A microscope arrangement for three-dimensionally recording a sample and for presenting three-dimensional images of the sample; comprising:
an image recording unit for ascertaining recordings of the sample;
an image processing unit for producing three-dimensional images of the sample from the recordings of the image recording unit; and
at least one display unit for three-dimensionally presenting the three-dimensional images produced of the sample;
wherein said microscope arrangement is configured for producing and presenting the three-dimensional images of the sample with an image repetition frequency of at least 1 image per second.

2. The microscope arrangement as claimed in claim 1, wherein the image recording unit is embodied for ascertaining two-dimensional recordings of the sample, and wherein the two-dimensional recordings have different focus settings.

3. The microscope arrangement as claimed in claim 1, wherein the three-dimensional images producible by the image processing unit are viewable in each case from a plurality of positions and/or from a plurality of sides.

4. The microscope arrangement as claimed in claim 1, wherein the three-dimensional images producible by the image processing unit in each case comprise a multiplicity of voxels distributed in three dimensions.

5. The microscope arrangement as claimed in claim 4, further comprising in the three-dimensional images producible by the image processing unit only the voxels that represent a surface of the sample are defined.

6. The microscope arrangement as claimed in claim 1, further comprising the three-dimensional images producible by the image processing unit are formed in each case from at least two of the three-dimensional recordings having a different focus setting.

7. The microscope arrangement as claimed in claim 1, further comprising an electronic control unit for controlling the image recording unit and/or the image processing unit and/or the display unit.

8. The microscope arrangement as claimed in claim 1, further comprising the at least one display unit is embodied in the form of a holographic display unit or a three-dimensional display unit that is wearable on a user's head.

9. The microscope arrangement as claimed in claim 1 further comprising the display unit comprises a plurality of partially transparent mirrors, which are arranged along the perimeter, and a projection unit, which is directed at the partially transparent mirrors and is embodied for the projection of in each case a partial image, assigned to a perspective, of the three-dimensional images onto the individual partially transparent mirrors.

10. The microscope arrangement as claimed in claim 9, wherein the partially transparent mirrors are arranged like the side faces of a pyramid or in the form of a spheroid, and in that the projection unit is directed onto the pyramid or onto the spheroid from above.

11. The microscope arrangement as claimed in claim 1, further comprising a three-dimensional printer for outputting a three-dimensional model of the sample under the microscope.

12. The microscope arrangement as claimed in claim 1, further comprising the image recording unit is embodied for recording images with an extended depth of field, for which purpose the image recording unit comprises a microsystem having mechanically movable micromirrors.

13. The microscope arrangement as claimed in claim 7, wherein the electronic control unit is configured for the simultaneous operation by a plurality of users.

14. The microscope arrangement as claimed in claim 7, wherein the electronic control unit is configured for performing a method for extending the depth of field, said method comprising the following steps:
recording the two-dimensional recordings of the sample, wherein the recordings are recorded with different focus settings, with the result that the recordings form a focus stack; and
presenting the individual recordings in a temporal succession, as a result of which an imaged presentation of the sample with an extended depth of field is produced.

15. The microscope arrangement as claimed in claim 14, wherein the electronic control unit is furthermore configured for performing a further step of the method for extending the depth of field which is to be performed after the recording of the recordings and in which the recordings are prepared by removing unsharp image portions in the individual recordings, wherein the individual prepared recordings are presented in a temporal succession, as a result of which an imaged presentation of the sample with an extended depth of field is produced.
